(19) United States
(12) Patent Application Publication
(10) Pub. No.: US 2011/0232088 A1
(43) Pub. Date: Sep. 29, 2011

(54) INTEGRATION OF COAL FIRED STEAM PLANTS WITH INTEGRATED GASIFICATION COMBINED CYCLE POWER PLANTS

(75) Inventors: David W. Wakefield, Houston, TX (US); Robert G. Jackson, Houston, TX (US)

(73) Assignee: ECONO-POWER INTERNATIONAL CORPORATION, Houston, TX (US)

(21) Appl. No.: 13/154,201

(22) Filed: Jun. 6, 2011

Related U.S. Application Data
(63) Continuation of application No. 11/759,658, filed on Jun. 7, 2007.

(51) Int. Cl. B23P 6/00

(52) U.S. Cl. 29/888.011

(57) ABSTRACT

A method of improving the output and efficiency of a pulverized coal plant by integration with an integrated gasification combined cycle plant. Specifically, embodiments of the invention provide improvements in the performance of an existing coal steam turbine electrical generating plant by the addition of coal gasifiers, a gas turbine and a heat recovery steam generator.

### CROSS REFERENCE TO RELATED APPLICATIONS

This Application is a continuation of U.S. application Ser. No. 11/759,658, filed on Jun. 7, 2007.

### FEDERALLY SPONSORED RESEARCH

Not applicable.

### REFERENCE TO MICROFICHE APPENDIX

Not applicable.

### FIELD OF THE INVENTION

The invention is directed to an electricity generating plant, more particularly to the integration of a coal fired steam plant and an integrated gasification combined cycle power plant.

### BACKGROUND OF THE INVENTION

In conventional electricity generation plants using coal to produce steam, the steam cycle typically has three pressure levels with the intermediate steam being reheated to the temperature of the high pressure section. In addition, the boiler feed water is heated by steam extracted from a steam turbine, particularly the low pressure section of the steam turbine.

To improve the efficiency of the steam cycle, a gas turbine is integrated with the steam plant. The gas turbine operates on fuel gas generated by the gasification of coal and lowers the levels of the emissions and the amount of water required. In an integrated gasification combined cycle (IGCC) plant, the highest temperature of the steam cycle is at a much higher temperature than in a conventional steam cycle, with steam being generated by the recovery of heat from the exhaust of the gas turbine. In addition, the gas turbine operates on fuel gas produced by the gasification of coal and can thus be considered to operate on coal.

In some embodiments of the invention, the integration of the IGCC uses the existing boiler, the steam turbine, the coal and ash handling systems while at the same time increasing the total output of the plant; improving the efficiency in the use of the coal and lowering the emissions of the oxides of carbon, nitrogen and sulfur.

In previous integration schemes, the heat recovery steam generator of the IGCC has been designed to generate steam at conditions identical to those required by the existing steam turbine to replace the existing boiler. By operating the heat recovery steam generator of the IGCC at the same conditions of the existing steam plant, steam is delivered to the intermediate pressure steam turbine and may be added to either the intermediate pressure or the low pressure sections of the steam turbine, or both.

In some cases, an extra steam turbine may be used to increase the power output, while, in other cases, the amount of steam needed to be supplied by the existing boiler may be reduced until the net overall steam turbine generator power remains the same.

In other cases, feed water heating may be accomplished by using the heat from the exhaust of the gas turbine and in other cases exhaust from the IGCC plant can be ducted into the draft fans of the boiler.

Since the fuel as produced by the gasification plant will be cleaned of objectionable components, such as sulfur, and the nature of the fuel is such that it produces less undesirable nitrogen oxide in its combustion, the gas exhausting from the stack will contain less objectionable emissions and thereby eliminate incremental emissions from the total expanded plant and improve the overall efficiency of the plant. This proposed method may encompass any or all of the above examples.

### SUMMARY OF THE INVENTION

Embodiments of the invention provide improvements in the performance of an existing coal steam turbine electrical generating plant by the addition of coal gasifiers, a gas turbine and a heat recovery steam generator (HRSG). The additional equipment increases the electrical output of the plant.

Performance of the existing plant may be improved by any or all of the following: a) generating steam in the HRSG at the steam conditions at the stop valve of the high pressure steam turbine; b) generating steam in the HRSG at the steam conditions at the stop valve of the intermediate pressure steam turbine; c) removing the sulfur in the coal converted to fuel gas in the coal gasifiers; d) reducing the carbon dioxide emissions per kilowatt of power generated by the reconfigured plant; e) reducing the amount of deleterious nitrogen oxides because of the combustion characteristics of the fuel gas; and f) improving the efficiency of the existing plant by discharging the hot gas leaving the HRSG into the air box of a boiler which also offers reduction in production of nitrogen oxides.

The operating efficiency of low pressure gasifiers used in the IGCC plant may be increased by extracting air from the outlet of the gas turbine compressor and passing it through an expander to reduce the pressure to that required by the gasifier while also producing power.

Certain embodiments of this invention are not limited to any particular individual features disclosed, but include combinations of features distinguished from the prior art in their structures and functions. Features of the invention have been described so that the detailed descriptions that follow may be better understood, and in order that the contributions of this invention to the arts may be better appreciated. These may be included in the subject matter of the claims to this invention. Those skilled in the art who have the benefit of this invention, its teachings, and suggestions will appreciate that the conceptions of this disclosure may be used as a creative basis for designing other structures, methods and systems for carrying out and practicing the present invention. This invention is to be read to include any legally equivalent devices or methods, which do not depart from the spirit and scope of the present invention.

### BRIEF DESCRIPTION OF THE DRAWINGS

FIG. 1 is a schematic flow sheet of a conventional pulverized coal power using a three pressure steam cycle with reheat of the steam exiting the high pressure turbine and with the feed water to the boilers heated by steam extracted from various positions on the steam turbines.

FIG. 2 is a schematic diagram of an IGCC plant.

FIG. 3 is a schematic diagram of a combination of an IGCC plant and an existing conventional pulverized coal power plant using a 3 pressure steam cycle with reheat of the steam exiting the high pressure turbine.

### DESCRIPTION OF THE PREFERRED EMBODIMENTS

To one of skill in this art that has the benefit of this invention's realizations, teachings, disclosures, and suggestions, other purposes and advantages will be appreciated from the following description and the accompanying drawings. The detail in the description is not intended to thwart this patent's object to claim this invention no matter how others may later disguise it by variations in form or additions of further improvements. These descriptions illustrate certain preferred embodiments and are not to be used to improperly limit the scope of the invention, which may have other equally effective or legally equivalent embodiments.

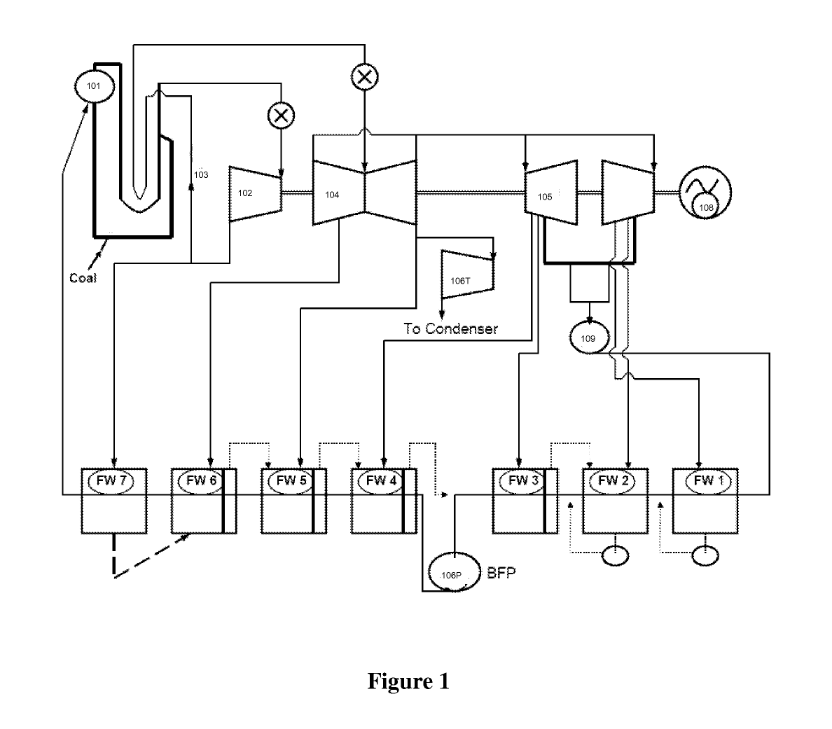

With regard to FIG. 1, an embodiment of a conventional pulverized coal power plant typically includes a boiler (101) in which pulverized coal is burnt to produce hot gas that evaporates water to produce high pressure steam at a high temperature to drive a high pressure steam turbine (102). The exiting steam from the high pressure steam turbine is separated into two streams, one which is returned to the boiler (101) to be re-heated to the same temperature as the high pressure steam (103) and another to heat the feed water to a boiler (FW7).

The re-heated steam passes to an intermediate pressure turbine (104) from which a major portion exits to a lower pressure turbine (105). Minor portions from the intermediate pressure turbine (104) exit to one or more boilers (FW5) and (FW6) to help heat the feed water and to supply a steam turbine (106T) that drives a boiler feed water pump (106P). Additional steam is extracted from the low pressure turbine to provide heat to one or more feed water heaters (FW3), (FW2) and (FW1). The remainder of the low pressure steam passes to a condenser (109). Power is produced by the low pressure steam turbine (105) in an electrical generator (108). Condensed water from the low pressure steam turbine (105) returns to the boiler (101) via the feed water heaters.

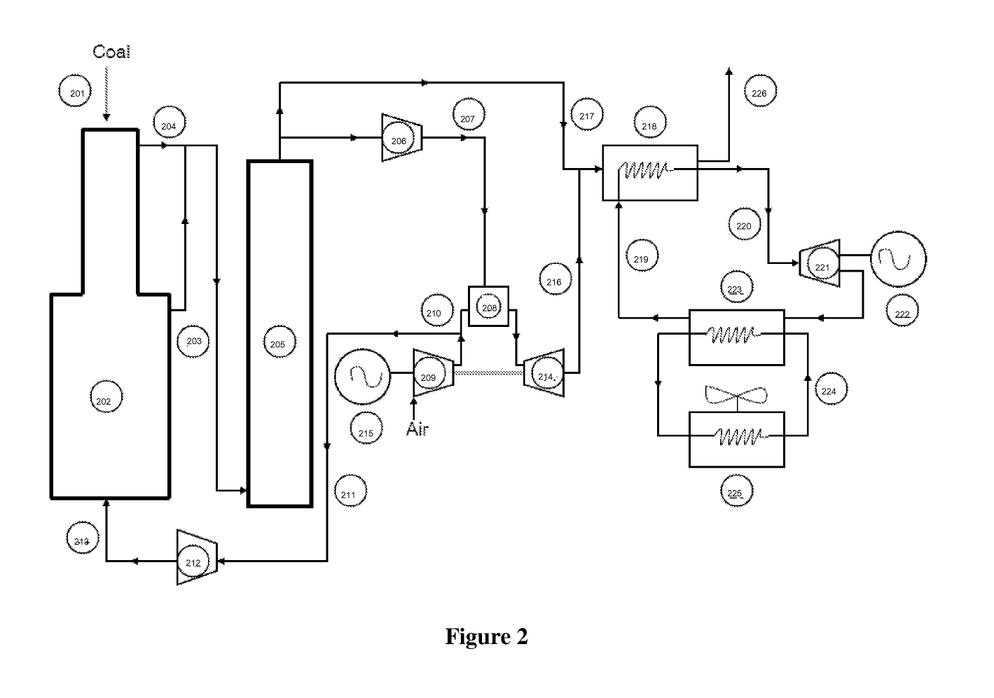

With regard to FIG. 2, an embodiment of a typical IGCC plant has coal (201) being passed into a gasifier (202) to be burned to produce fuel gas that leaves the gasifier at one or more exits (203) and (204) before being mixed and passed into a scrubber tower (205) to remove sulfur from the fuel gas. In alternate embodiments, if carbon dioxide is to be sequestered from the plant, a shift reactor may be placed before the scrubber to convert some or all of the carbon monoxide in the gas to carbon dioxide and hydrogen.

In another alternate embodiment, carbon dioxide may also be removed in the scrubber (205). A portion of the fuel gas enters a compressor (206), exiting at a high enough pressure (207) for entry to a combustion chamber (208) of a gas turbine (214). Exiting air from a gas turbine compressor (209) is split into two streams (210) and (211). Stream (211) passes to an expander (212) and the exhaust (213) is sent to the bottom of the gasifier (201). Stream (210) enters the combustion chamber (208) to provide the oxygen necessary for the gas (207) to burn. The hot gas from the combustion chamber (208) passes into the gas turbine (214), creating the power needed to drive the compressor (209) and a generator (215). Exhaust gas (216) from the gas turbine (214) passes to a heat recovery steam generator (218) where it is cooled by heat exchange with water (219) to provide high pressure steam (220) to drive a steam turbine (221) and electricity generator (222). Steam exiting the steam turbine (221) is cooled in a condenser (223) by cold water (224) supplied from a cooling tower (225).

In an alternate embodiment, the steam (221) is cooled by an air cooled condenser. In another alternate embodiment, more steam and power may be produced by burning a portion of the coal gas (217) in the entry duct of the heat recovery steam generator (218). Exhaust from the HRSG (218) is directed to a discharge stack (226).

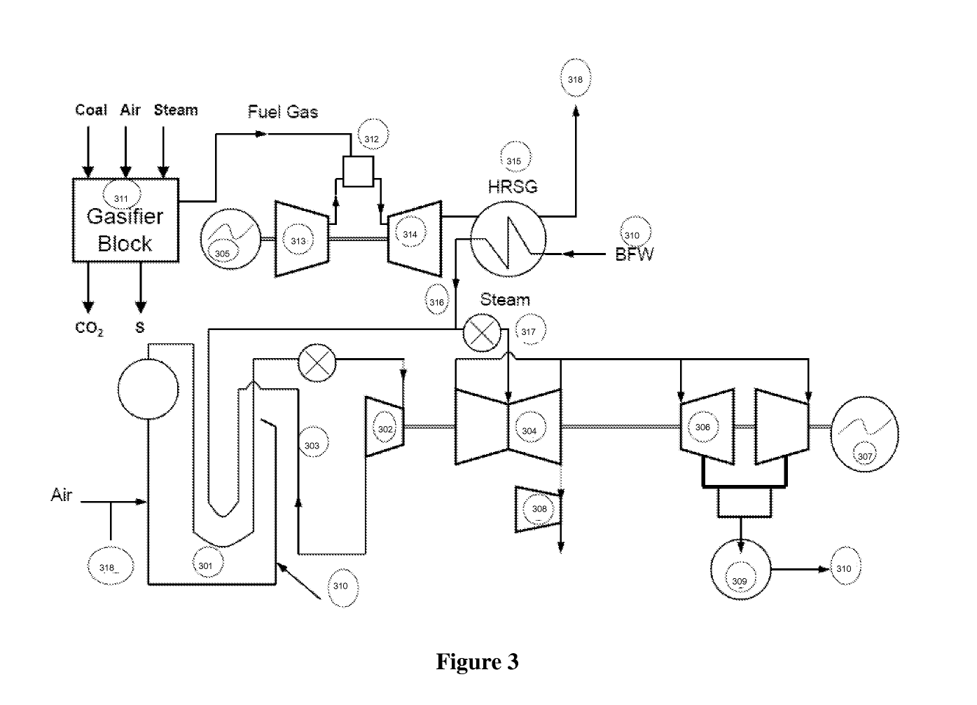

With regard to FIG. 3, in a preferred embodiment, the combined IGCC plant and conventional pulverized coal power plant are integrated and includes pressurized water (310) entering a boiler (301) to be converted into steam at a high pressure and temperature and being fed to a steam turbine (302).

From the turbine, the exhaust steam (303) returns to the boiler (301) to be reheated to the same temperature as the steam exiting the boiler. From the boiler, the exhaust steam mixes with steam (316) produced in an HRSG (315) of an IGCC at the same temperature and pressure. The mixture enters the intermediate pressure turbine (304). A small amount of the steam exiting the intermediate pressure turbine is used in a turbine (308) that drives a boiler feed water pump. The majority passes to a low pressure turbine (306) that drives an electric generator (307). The low pressure steam passes to a condenser (309) to be converted to water (310).

The IGCC plant consists of a gasifier block (311) in which coal, steam and air are converted to fuel gas. The fuel gas is cleaned of sulfur and in some cases carbon dioxide before passing to a combustion chamber (312) of a gas turbine consisting of an air compressor (313) and an expander (314) from which the hot exhaust gases flow into the HRSG (315) to convert boiler feed water (310) into intermediate pressure steam (316). From the HRSG, the gas (318) may be exhausted through a flue or passed to the air box of the boiler. The gas turbine (13) drives an electric generator (305).

Typically, if electric power is generated using a coal-based integrated combined cycle, gasification is carried out in one large gasifier, operating with oxygen as the oxidant and a spare gasifier to provide for reliability. Greater flexibility, reliability and better economics may be attained using multiple modular gasifiers and components operating on air as the gasification agent. To further improve the performance of an existing steam turbine generating station, replacement of the boiler presently generating the steam may be done by utilizing the HRSG of an IGCC.

In a preferred embodiment, the existing boiler may be retained and steam from the HRSG may be generated at such a pressure that it can be added to the steam produced by the existing boiler. As an example of this, an IGCC plant having an air fired two-stage gasifier supplies fuel gas to a gas turbine to produce steam by an HRSG using the exhaust of the gas turbine. The gas leaving the gasifiers may be treated to remove about 99% of the sulfur while about two thirds of the carbon monoxide content may be converted to hydrogen and carbon dioxide. The carbon dioxide may be removed before the gas is used. This may enable about 63% of the carbon in the coal used in the IGCC plant to be sequestered.

As an example, the above arrangement (IGCC and gas turbine) is linked with a power plant that presently generates about 272,000 KW made up of about 152,000 KW from the high pressure/intermediate pressure turbine set and about 120,000 KW from the low pressure turbine set. The boiler produces about 1,732,420 pounds per hour of steam at pressure of about 2,400 pounds per square inch absolute (psia) and a temperature of about 1050° F. The steam passes through the high pressure steam turbine in which it expands to a pressure of about 577 psia. About 183,901 pounds per hour of this steam is used for feed water heating while the rest, about 1,542,696 lb/hour, is returned to the boiler and reheated to about 1050° F. In a preferred embodiment, the exhaust from a Frame 7EA gas turbine is passed to a HRSG generating steam at about 577 psia and about 1050° F. At that pressure and temperature, the HRSG may produce about 308,647 lb/hour of steam. Adding that steam to the reheat steam from the existing boiler may increase the steam flow to about 1,851,343 lb/hour into the intermediate pressure turbine and about 1,645,073 lb/hour through the low pressure turbine. In the original design, about 55% of the power generated by the high pressure/intermediate pressure set is generated by the intermediate pressure turbine. As a result, the output of the intermediate pressure turbine may increase from about 84,140 KW to about 101,350 KW and the output of the low pressure turbine could increase from about 120,000 KW to about 150,930 KW, which is an increase in power of about 48,140 KW. However, it is the existing turbines may not be able to operate at such a high output.

Therefore, in an alternate embodiment, the performance of the new plant may be more efficient and less polluting if the steam production of the existing boiler was reduced so that the net output of the three steam turbines remain the same at about 272,000 KW, by reducing the flow of coal and steam into the boiler by about 16%. The output of the high pressure/intermediate pressure turbine may be changed to about 142,650 KW and the low pressure turbine to about 129,350 KW. The amount of coal burned would be proportionally reduced. Additionally, the 7EA gas turbine may produce a net output of about 63,300 KW making a grand total for the modified plant of about 335,300 KW.

By passing the hot gas from the HRSG to the air box of the boiler and by integrating the feedwater heating of the total plant additional improvements may be realized, including the reduction of carbon dioxide emissions from about 2.15 pounds per kilowatt of electricity generated to about 1.69 pounds per kilowatt. Sulfur dioxide emissions from the combined flue gases may also be reduced by about 15%.

Other size pulverized coal plants would offer similar efficiency improvement and emission reduction.

In conclusion, therefore, it is seen that the present invention and the embodiment(s) disclosed herein are well adapted to carry out the objectives and obtain the ends set forth. Certain changes can be made in the subject matter without departing from the spirit and the scope of this invention. It is realized that changes are possible within the scope of this invention and it is further intended that each element or step recited is to be understood as referring to all equivalent elements or steps. The description is intended to cover the invention as broadly as legally possible in whatever forms it may be utilized.

We claim:

1. A method of improving the output and efficiency of a pulverized coal plant, comprising the steps of: integrating a pulverized coal plant with an integrated gasification combined cycle plant, wherein the integrated gasification combined cycle plant provides a) steam to one or more steam turbines of the pulverized coal plant, in addition to steam generated in the pulverized coal plant; b) heat to a feed water heater in the pulverized coal plant, in addition to heat generated in the pulverized coal plant; and/or c) hot exhaust gas into an air box of one or more boilers in the pulverized coal plant.

2. The method according to claim 1, wherein the steam generated in a heat recovery steam generation unit of the integrated gasification combined cycle plant is at a pressure and temperature equal to those of the one or more steam turbines of the pulverized coal plant and the steam turbines are high pressure steam turbines.

3. The method according to claim 1, wherein the steam generated in the heat recovery steam generation unit of the integrated gasification combined cycle plant is at a pressure and temperature equal to those of a reheat steam stream for the one or more steam turbines of the pulverized coal plant and the steam turbines are intermediate pressure steam turbines.

4. The method according to claim 1, wherein fuel gas produced by a gasifier of the integrated gasification combined cycle plant has a major proportion of its carbon monoxide converted to carbon dioxide and hydrogen and the carbon dioxide is removed for sequestration or other use.

5. The method according to claim 1, wherein a coal and ash handling system of the pulverized coal plant also serves the integrated gasification combined cycle plant.

6. The method according to claim 1, wherein exhaust from the integrated gasification combined cycle plant is directed to the air box or forced draft system of the existing pulverized coal plant.

7. The method according to claim 2, wherein the one or more high pressure steam turbines of the pulverized coal plant comprise a three (3) pressure reheat power plant.

8. The method according to claim 3, wherein the one or more intermediate pressure steam turbines of the pulverized coal plant comprise a three (3) pressure reheat power plant.
